(19) United States
(12) Patent Application Publication
(10) Pub. No.: US 2007/0120786 A1
(43) Pub. Date: May 31, 2007

(54) Sequence design in a display system

(75) Inventors: Harold E. Bellls II, Garland, TX (US); Gregory James Hewlett, Richardson, TX (US); Bryce Daniel Sawyers, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/287,860

(22) Filed: Nov. 28, 2005

(51) Int. Cl. G09G 3/34

(52) U.S. Cl. 345/84

(57) ABSTRACT

Method for designing color display sequences in a display system using rapidly switching light sources. A preferred embodiment comprises determining a number of bit segments in a frame time, determining a color sequence, and specifying a bit sequence from the color sequence. The bits in the bit sequence are delineated by a switching of a rapidly switching light source or a state change of a light modulator. The use of the rapidly switching light source can permit the specification of bits that are shorter than a minimum duration of a state change of the light modulator and the possible elimination of a segmented color filter that can enable adjustments to the color point of the display system to meet changing operating conditions.

### TECHNICAL FIELD

The present invention relates generally to a method for display systems, and more particularly to a method for designing color display sequences in a display system using rapidly switching light sources.

### BACKGROUND

Many modern display systems make use of a spatial light modulator to modulate light provided by a light source to create images that can be viewed on a display screen. For example, a display system making use of a digital micromirror device (DMD) as the spatial light modulator modulates light reflecting off the micromirrors on the surface of the DMD to create picture elements of images being displayed, while a display system making use of a liquid crystal display (LCD) as the spatial light modulator modulates light passing through the LCD (or reflecting off the surface of the LCD) to create picture elements of images being displayed.

These display systems typically make use of a high-intensity light source, such as electric discharge arc lamps, to provide the light necessary to display the images on the display screen. The high-intensity light sources have advantages such as an ability to produce a lot of light as well as being relatively inexpensive and reliable. The high-intensity light sources can produce a wide spectrum light (essentially white light) or through the use of color filters, light of specific colors, such as red, green, and blue, as desired.

One disadvantage of the prior art is that the high-intensity light sources have very slow on/off cycle times. Therefore, during normal operation, the high-intensity light sources are left in an on state. To produce light of desired color, a segmented color filter (such as a color wheel that is rotated at a given rate) is placed in the optical path of the display system. Since the segments of the segmented color filter are fixed, it is not possible to dynamically change the amount of time allocated to a given color. Therefore, it can be difficult to change the chromatic nature of the light being used in the display system to optimize display quality in different environments.

Another disadvantage of the prior art is that the segments in the segmented color filter are fixed, therefore it is not possible to change the order in which colors are being displayed by the display system or a display duration for each color. Hence, it is not possible to change the display sequence to help reduce some chromatic distortion and artifacts that are visible when certain color combinations are displayed in sequence. This typically cannot be optimized a priori since it can depend upon the operating environment of the display system or the nature of the images being displayed, for example.

### SUMMARY OF THE INVENTION

These and other problems are generally solved or circumvented, and technical advantages are generally achieved, by preferred embodiments of the present invention which provides a method for designing color display sequences in a display system using rapidly switching light sources.

In accordance with a preferred embodiment of the present invention, a method for creating a bit sequence is provided. The method includes determining a number of bit segments in a frame time and determining a color sequence. The method also includes specifying a bit sequence from the color sequence. Each bit in the bit sequence is delineated by a switching of a rapidly switching light source or a state change of a light modulator.

In accordance with another preferred embodiment of the present invention, a method for creating a bit sequence for displaying image data is provided. The method includes computing a frame time, determining a number of bit segments displayable in the frame time, and determining a color sequence. The color sequence is based upon a desired color point. The method also includes ordering the color sequence and specifying a bit sequence from the ordered color sequence. Each bit in the bit sequence is delineated by a switching of a rapidly switching light source or a state change of a light modulator.

An advantage of a preferred embodiment of the present invention is that by exploiting the capabilities of the rapidly switching light source, it can be possible to adjust color separation and improve image quality by reducing artifacts, such as transition noise, that can have a negative impact on image quality. For example, color sequences can be optimized to meet display system environmental conditions.

A further advantage of a preferred embodiment of the present invention is that the distribution of colors being displayed can be changed to alter the color point of the display system. This can allow for adjustment of properties such as white balance, which can change depending upon the environment in which the display system is being used.

Yet another advantage of a preferred embodiment of the present invention is that the on time of the rapidly switching light source can be adjusted to maximize light output, light source life, or both.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a portion of an SLM display system, according to a preferred embodiment of the present invention;

FIG. 2a is a diagram of segmented color filter state as a function of time;

FIG. 2b is a diagram of a color sequence produced by a rapidly switching light source capable of producing light of differing wavelengths, according to a preferred embodiment of the present invention;

FIGS. 3a through 3c are diagrams of LED light output as a function of time, according to a preferred embodiment of the present invention;

FIG. 4 is a diagram of the decomposition of light into component colors, according to a preferred embodiment of the present invention;

FIGS. 5a through 5d are diagrams illustrating space-time plots of data loads and resets issued to the SLM display system, according to a preferred embodiment of the present invention; and

FIGS. 6a and 6b are diagrams of sequences of events in the specification of bit sequences, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a spatial light modulator (SLM) display system wherein a digital micromirror device (DMD) functions as the SLM and light-emitting diodes (LED) are used as the rapidly switching light source. The invention may also be applied, however, to SLM display systems that make use of alternate SLM technology, such as liquid crystal displays (LCD), deformable mirrors, micro electrical machine systems (MEMS), liquid crystal on silicon (LCoS), and so forth, as well as SLM display systems that make use of other forms of rapidly switching light sources, such as lasers, laser diodes, and so on.

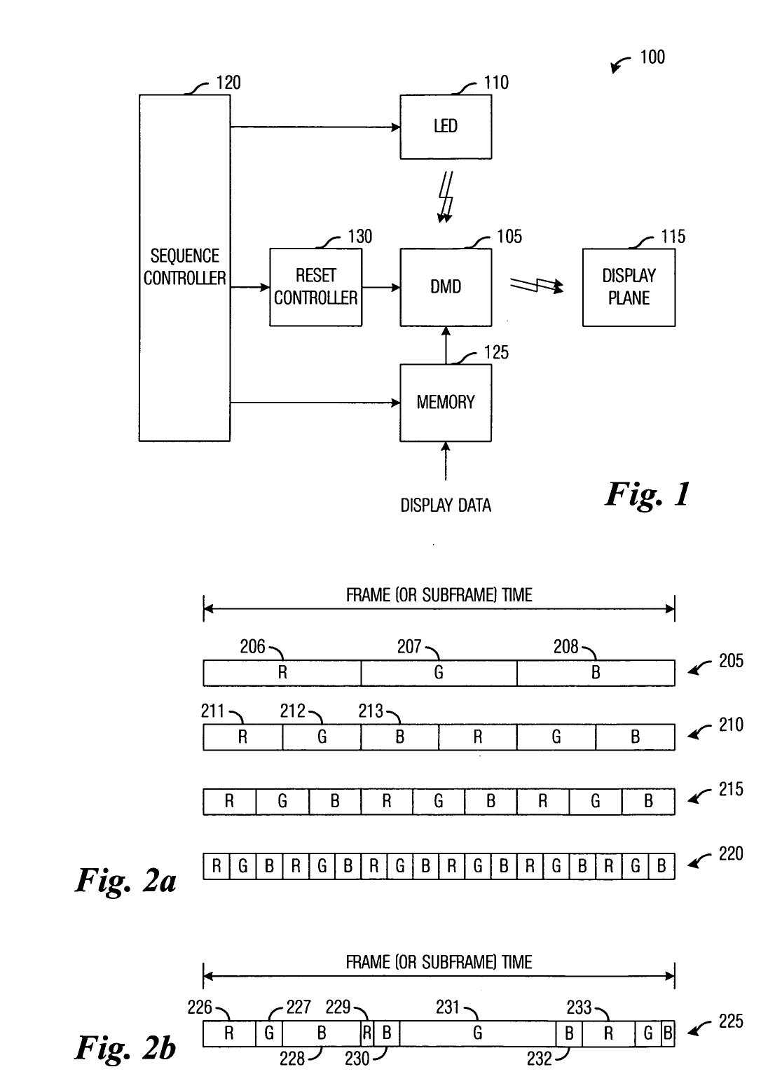

With reference now to FIG. 1, there is shown a diagram illustrating a portion of an SLM display system 100, according to a preferred embodiment of the present invention. As shown in FIG. 1, the portion of the SLM display system 100 includes a spatial light modulator 105, such as a digital micromirror device (DMD) array, and a rapidly switching light source 110. In addition to micromirrors, other light modulator technology, such as liquid crystal, liquid crystal on silicon, deformable mirrors, actuated mirrors, and so forth, can be used in the spatial light modulator 105. The rapidly switching light source 110 should be able to switch from on to off and off to on at a faster rate than the light modulators in the spatial light modulator 105 are capable of changing state. The rapidly switching light source 110 may be a single LED or an array of LEDs. The array of LEDs may be made up of LEDs of a single color or differently colored LEDs may be used. Furthermore, the rapidly switching light source 110 is capable of producing light at various intensities. Light from the rapidly switching light source 110 reflects from the spatial light modulator 110 and onto a display plane 115. Although discussed as making use of LEDs, the rapidly switching light source 110 can make use of lasers, laser diodes, and so on.

A sequence controller 120 can provide instructions to the rapidly switching light source 110 to control LED states, such as light on/off and color to produce. The sequence controller 120 can also access a memory 125, which can contain the data (pixel (picture element) information) of images to be displayed via the spatial light modulator 105. A reset controller 130, also controlled by instructions provided by the sequence controller 120, places the spatial light modulator 105 into a mode that allows it to accept new state change instructions from the sequence controller 120.

The use of a segmented color filter, such as a color wheel, in a DMD-based SLM display system, means that each component color (for example, red, green, or blue) will be displayed for a fixed amount of time during each frame time. The frame time can be divided equally or to take into account the nature of the light being produced by a light source, the frame time can be divided into unequal amounts for each of the various component colors. For example, if the segmented color filter has three segments (one for each of the three component colors red, green, and blue) and is to be divided equally, then the colors red, green, and blue will each be displayed for a time period substantially equal to one-third of the frame time. There may be a portion of the frame time dedicated for use in synchronization functions, resets, and so forth, so a sum of the display times for the three colors may not add up to be exactly equal to the frame time. Although the above example discusses an SLM display system that makes use of three component colors (red, green, and blue), the present invention can be applicable to SLM display systems with different numbers of component colors, such as four, five, six, and so forth. Therefore, the discussion of three component colors should not be construed as being limiting to either the scope or the spirit of the present invention.

With reference now to FIG. 2a, there is shown a diagram illustrating segmented color filter states for a single frame time. The diagram shown in FIG. 2a illustrates the state of the segmented color filter over the single frame time or subframe time. If more than one set of image data is displayed within a single frame time, then a subframe time is the time used display a single set of image data. When the segmented color filter is in a state, then that state is in the optical path of the SLM display system and the wide-spectrum light produced by the light source of the SLM display system is being filtered to produce light color corresponding to the state. For example, if the segmented color filter is in a red state, then the light produced by the light source is filtered so that a red light is being produced by the SLM display system. The diagram shown in FIG. 2a is simplified to display only the state of the segmented color filter over the frame time and does not display other portions of the frame time when colored light is not being produced. For example, there are portions of the frame time that the segmented color filter effectively cuts off the light so that the mirrors in the DMD can become reset and synchronized. Such color filter states are not shown in FIG. 2a.

The diagram shown in FIG. 2a illustrates an exemplary segmented color filter with a given color sequence. Other color sequences are possible with other segmented color filter designs and do not change the spirit or scope of the present invention. A first trace 205 illustrates color filter states for a situation wherein the segmented color filter is changed at a rate so that the segmented color filter assumes one of the possible color states only one time within a frame time. Within the frame time, the color states change from red 206 to green 207 to blue 208. This rate of change for the segmented color filter is commonly referred to as one cycle rate (or simply 1×). If the segmented color filter were a color wheel, then the color wheel would be rotated at a rate so that the color wheel would make one complete revolution in a single frame time, for example.

A second trace 210 illustrates color filter states for a situation wherein the segmented color filter is changed at a rate so that the segmented color filter assumes one of the color states twice within a frame time. This rate of change for the segmented color filter is commonly referred to as two cycle rate (or simply 2×). The doubling of the cycle rate can be achieved by doubling the number of states in the segmented color filter or by changing the segmented color filter at twice the rate. Within the frame time, the color states change from red 211 to green 212 to blue 213. Comparing a duration of the color states shown in the first trace 205 to a duration of the color states shown in the second trace 210, the individual color states in the second trace 210 have a duration that is about one-half of that of the duration of the individual color states in the first trace 205. A third trace 215 illustrates color filter states wherein the segmented color filter is changed at a three cycle rate (3×) and a fourth trace 220 illustrates color filter state wherein the segmented color filter is change at a six cycle rate (6×).

Increasing the change rate of the segmented color filter state can result in improved image quality of the SLM display system with less color flickering and so on, since the color states change more rapidly and each color state has a shorter duration. However, even with an increased rate of color state change, the relative duration of the color states remain the same as set by the segmented color filter. For example, it is not possible to provide more (increasing the duration) of the color red while reducing the duration of the color blue, without changing the segmented color filter. According to a preferred embodiment of the present invention, by using a rapidly switching light source that can individually produce light in the desired colors and eliminating the segmented color filter, it is possible to change the duration of the individual colors. For example, if LEDs were used as the rapidly switching light source, then red, blue, and green LEDs can be used and the segmented color filter is no longer needed since the rapidly switching light source can produce the desired colors without needing filtering. Again, although the example discusses a three component color system, the present invention can be extended to color systems with a different number of component colors.

With reference now to FIG. 2b, there is shown a diagram illustrating an exemplary sequence 225 of colored light produced by an SLM display system, wherein the SLM display system features a rapidly switching light source with the capability of producing light at specific wavelengths, according to a preferred embodiment of the present invention. The sequence 225 illustrates the light produced by the SLM display system for a single frame time (or subframe time). The sequence 225 is meant to be an example of a potential sequence of light colors and is not intended to be limiting to the scope or the spirit of the present invention.

Since the rapidly switching light source in the SLM display system can produce light of different wavelengths (colors), the segmented color filter is no longer required. Therefore, it is possible for the SLM display system to change the sequence of colors produced by the rapidly switching light source to meet changing demands. As shown in FIG. 2b, a first red color 226 is followed by a first green color 227 and a first blue color 228. Then, instead of repeating the red, green, and blue sequence, the next colors produced by the rapid switch light source are a second red 229, a second blue 230, a second green 231, a third blue 232, and a third red 233, and so on. An actual colored light sequence can depend upon optimizations made by the designers of the SLM display system as well as external factors, such as the operating environment of the SLM display system, the desired power consumption, and so forth. For example, the designers may predetermine a series of different sequences based upon some typical operating environments, analysis of typical images, user display settings, and so on, and store them in a memory in the SLM display system. Then based upon input from the users, analyses of images being displayed, sensors capable of detecting the spectral characteristics of the operating environment, and so forth, one or more of the sequences can be selected by the SLM display system (typically, by the sequence controller 120 (FIG. 1)).

In addition to changing the color light sequence, the use of the rapidly switching light source can also permit a variation in the duration for each color light in the color light sequence. Because the segments of the segmented color filter had a fixed size, it was not possible to change the duration of each color filter state during use. However, since the segmented color filter is not required if the rapidly switching light source is capable of producing colored light, there can be variation in the duration for each color. The duration of a color can be dependent upon a need to produce a certain amount of light within a frame time. For example, if for some reason, there needs to be twice as much red colored light as blue colored light, the duration of the blue color can be halved and the duration of the red color can be doubled. For example, as shown in FIG. 2b, the duration of the first red color 226 is greater than the duration of the first green color 227, with both durations being shorter than the duration of the first blue color 228. This can allow for the customization of the light being produced by the SLM display system to meet performance requirements.

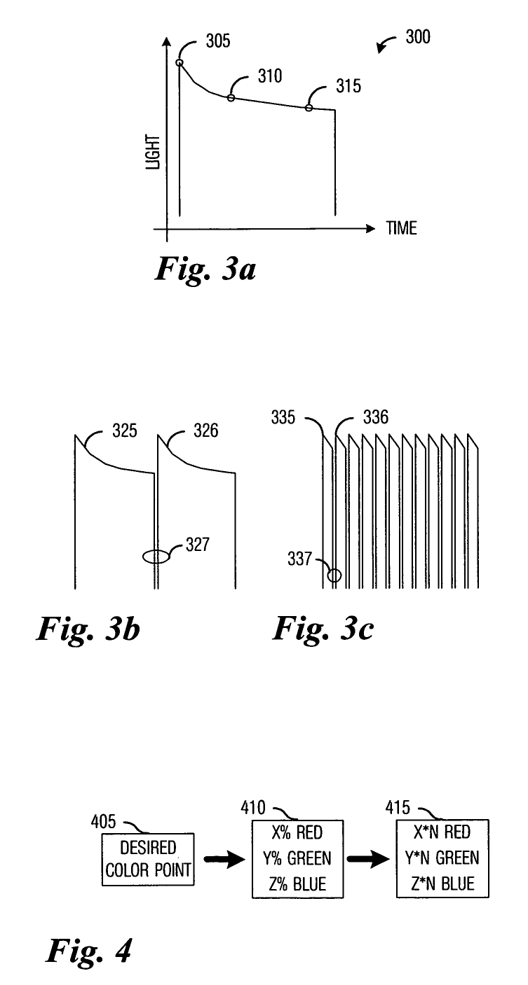

With reference now to FIGS. 3a through 3c, there are shown diagrams illustrating light output from an LED and techniques to increase light output from the LED, according to a preferred embodiment of the present invention. The diagram shown in FIG. 3a illustrates a data plot 300 of light output from the LED versus time. The data plot 300 shows that when the LED is initially powered on, it produces a maximum amount of light (point 305). The light output of the typical LED then rapidly drops, where the drop in the light output may exhibit a super linear behavior, over time until it reaches a point wherein a drop in the light output begins to slow (point 310), where the drop in the light output begins to exhibit a linear behavior. Finally, the light output of the typical LED may reach a point (point 315) where the light output may no longer decrease (or decrease very slowly) over time.

Since the light output from the typical LED can drop significantly over time under continuous operation, it can be possible to increase the light output from an LED rapidly switching light source by rapidly turning the LED on and then off rather than keeping the LED on. The diagrams shown in FIGS. 3b and 3c illustrate techniques for increasing the light output of the LED rapidly switching light source by turning on the LED for multiple short periods of time rather than keeping the LED on for an extended amount of time. The diagram shown in FIG. 3b illustrates the turning on of the LED for two time periods (shown in FIG. 3b as LED light output pulses 325 and 326) that is substantially equal to the amount of time shown in FIG. 3a. A small recovery period (shown as highlight 327) may be necessary to prevent overheating of the LED or LED drive circuitry. Additionally, the recovery period can permit the light output of the LED to stabilize. Similarly, the diagram shown in FIG. 3c illustrates turning on the LED for multiple short time periods, 12 as shown in FIG. 3c, such as time periods 335 and 336. The use of short time periods can maximize the light output since the light output of the LED has not had a chance to significantly drop prior to being turned off. Again, a small recovery period (shown as highlight 337) may be needed to prevent overheating and/or permitting stability of light output, and so forth.

With reference now to FIG. 4, there is shown a diagram illustrating a decomposition of a light with a desired color point into component colors and subsequent sequence specification to achieve the desired color point, according to a preferred embodiment of the present invention. It is possible to describe a color of light by specifying it as a combination of its component colors. For example, for a given color of light, it is possible to specify the given color of light as a combination of an amount of a red component, an amount of a blue component, and an amount of a green component. It is then possible to recreate the given color of light by combining the specified amounts of red, blue, and green. Again, although the example discusses a three component color light system, the present invention has applicability to light systems making use of different numbers of component colors.

However, an operating environment of the SLM display system can have an effect upon the visible color of the images being displayed by the SLM display system. For example, if the operating environment has lighting provided by fluorescent lamps, the light from the fluorescent lamps may provide a bluish cast to the images being displayed. Therefore, a sensor present in the SLM display system may be used to detect the spectral characteristics of the fluorescent lamps and the spectral characteristics can be used to make any necessary adjustments to the overall color of the images being displayed by the SLM display system.

Based upon the spectral characteristics of the operating environment of the SLM display system, a desired color point 405 may be computed for the overall color of the images being displayed by the SLM display system. The sequence controller 120 (FIG. 1) may be responsible for processing the spectral characteristics provided by the sensor and computing the desired color point 405. The desired color point 405 can be decomposed into the component colors 410. For example, the sequence controller 120 may compute that the desired color point 405 can be produced by the SLM display system by setting the rapidly switching light source to produce a red light X percent of the frame time, a green light Y percent of the frame time, and a blue light Z percent of the frame time. Then, based upon the frame time and the computed percentages (X, Y, and Z), the sequence controller 120 can compute an amount of time within the frame time to be allocated to each color. For example, if within the frame time, it is possible for the rapidly switching light source to produce N units of light, commonly referred to as bit segments, then during the frame time, the rapidly switching light source can produce X*N units of red light, Y*N units of green light, and Z*N units of blue light, as shown at block 415.

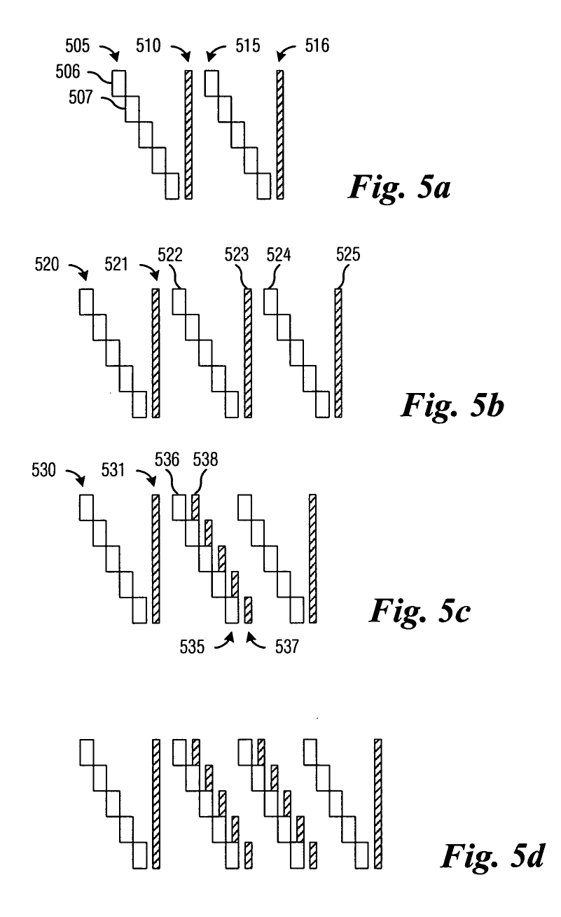

With reference now to FIGS. 5a through 5d, there are shown diagrams illustrating space-time plots of data loads and resets issued to the SLM display system for different length bit subsegments, according to a preferred embodiment of the present invention. Not all LEDs exhibit the light output behavior shown in FIG. 3a, for these LEDs and for other forms of rapidly switching light sources, it may be desirable to optimize the on time of the light source. Optimization of the on time may result in a maximization of the on time of the light source, since a minimization of the on/off switching may have a positive effect on the useful life of the light source, reducing the amount of time that the rapidly switching light source is off (which can increase the number of bit segments displayable within a frame time), and so forth.

For a typical SLM display system, image data to be displayed is loaded into the array of light modulators, such as the DMD, in multiple steps. Instead of loading all of the image data in a single load instruction, the array of light modulators may be loaded with a sequence of load instructions. For example, the DMD may be partitioned into K sections, then K load instructions would be issued with each of the K load instructions loading one of the K sections of the DMD. It is possible to take advantage of the multiple load instructions to maximize the time that the rapidly switching light source remains in an on state.

The diagram shown in FIG. 5a illustrates a space-time plot of data loads and resets for a bit subsegment of length one, according to a preferred embodiment of the present invention. The diagram shown in FIG. 5a illustrates a first sequence of loads 505, which includes a sequence of individual load instructions, such as load 506 and load 507. As shown in FIG. 5a, five individual load instructions are needed to load the image data into the array of light modulators. Although shown in FIGS. 5a through 5b as having five individual load instructions in a single load sequence, the number of individual load instructions in a load sequence can be dependent upon the design of the array of light modulators. Therefore the use of five load instructions should not be construed as being limiting to the scope or the spirit of the present invention.

After the individual load instructions are issued, a first global reset 510 can be issued to have the individual light modulators in the array of light modulators assume a state that corresponds to the image data that was loaded. Once the first global reset 510 executes, the image data is displayed. During the display of the image data is being displayed, image data for a subsequent subsegment is being loaded into the array of light modulators by a second sequence of loads 515. A second global reset 516 results in a change of state of the light modulators corresponding to the newly loaded image data.

For bit subsegments of length greater than one, it is possible to simply repeat the procedure shown in FIG. 5a. The diagram shown in FIG. 5b illustrates a space-time plot of data loads and resets for a bit subsegment of length two, according to a preferred embodiment of the present invention. A third sequence of loads 520 can load image data for the first bit of the two-bit subsegment and a third global reset 521 instructs the light modulators in the array of light modulators to assume states corresponding to the newly loaded image data. A fourth sequence of loads 522 and a fourth global reset 523 perform the image data load and display for the second bit of the two-bit subsegment, while a fifth sequence of loads 524 and a fifth global reset 525 does the same for a different bit subsegment.

With reference now to FIG. 5c, there is shown a diagram illustrating a space-time plot of data loads and resets for a bit subsegment of length two, wherein instruction staggering is used to increase a number of bit segments displayable within a given amount of time, according to a preferred embodiment of the present invention. Rather than waiting until all individual loads in a sequence of loads are completed before issuing a global reset, a sectional reset can be issued immediately after each individual load. This instruction staggering can increase the number of bit segments displayable within a given amount of time.

The diagram shown in FIG. 5c illustrates a sixth sequence of loads 530 that is used to load image data for a first bit segment of a bit subsegment of length two. It is followed with a sixth global reset 531. During the display time of the first bit segment, a seventh sequence of loads 535 is started to load the second bit segment of the two-bit subsegment. However, rather than waiting until the seventh sequence of loads 535 completes, a sequence of sectional resets 537 is issued. Each sectional reset in a sequence of sectional resets is issued immediately after a corresponding individual load. For example, individual load instruction 536 is followed by sectional reset 538. Since the color of light being produced by the rapidly switching light source is maintained, the change of the light modulators does not require a time when the rapidly switching light source is turned off. The diagram shown in FIG. 5d illustrates a space-time plot of data loads and resets for a bit subsequence of length three, wherein instruction staggering is used to increase a number of bit segments displayable within a given amount of time, according to a preferred embodiment of the present invention. The technique can be extended for a bit subsegment of arbitrary length.

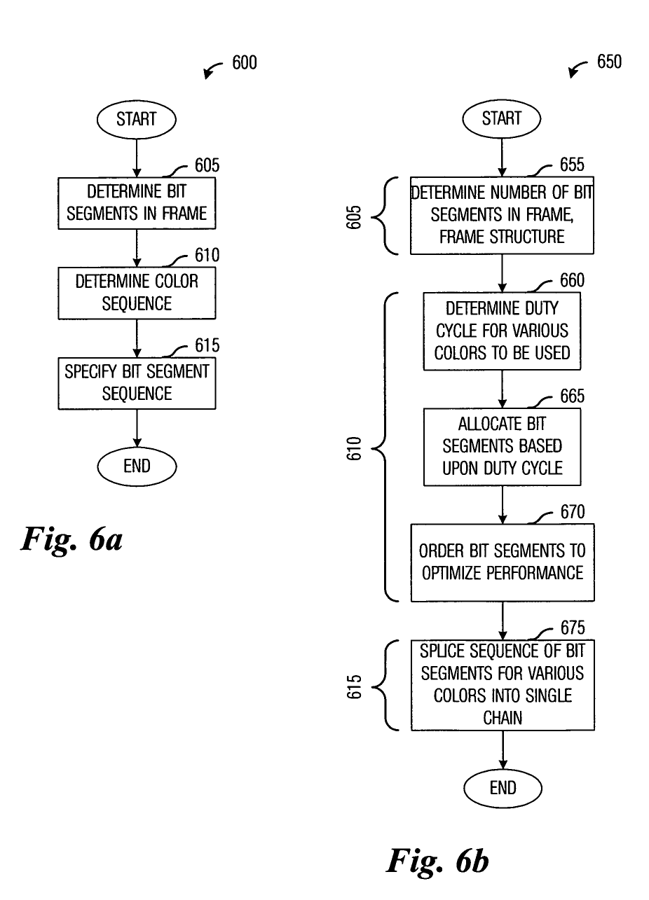

With reference now to FIGS. 6a and 6b, there are shown diagrams illustrating sequences of events in the specification of bit sequences for an SLM display system, according to a preferred embodiment of the present invention. A sequence of events 600, shown in FIG. 6a, illustrates a high-level view of the design and specification of a bit sequence for the SLM display system. The design and specification of a bit sequence can begin with a determination of a number of bit segments within a frame time (block 605). The determination of the number of bit segments displayable within the frame time can be a function of a minimum display time of the SLM display system (the minimum display time can also be referred to as a minimum displayable amount of light and is typically assigned to a least significant bit of image data), a duration of the frame time, a device load time, and so forth. For example, for an SLM display system with a given frame rate and device load time, the number of bit segments is approximately equal to 1/(frame rate*device load time).

After determining the number of bit sequences displayable in the frame time (block 605), it is possible to determine a color sequence (block 610) that can be displayed within the frame time. The determination of the color sequence can be dependent upon factors such as the physical and optical characteristics of the rapidly switching light source, the operating environment of the SLM display system, the type of images being displayed (spectral characteristics of images), the number of bits to be displayed, and so on. Once the color sequence is determined (block 610), the color sequence can be ordered on an individual component color basis, and then the bit sequence can be specified (block 615). The creation of the bit sequences can be created by the switching of the rapidly switching light source and/or the state changes of the light modulators in the SLM. The specification of the bit sequence may involve a distribution of the specified color sequence throughout the frame time in such a manner that the image quality can be optimized. For example, certain distributions of the color sequence can minimize visible noise, such as pulse-width modulation (PWM) transition noise, as well as minimize color artifacts that can be the result of certain sequences of colors that can be avoided if the sequences are broken.

A sequence of events 650, shown in FIG. 6b, illustrates an exemplary design and specification of a bit sequence for an SLM display system. The design and specification of the bit sequence can begin with a determination of a number of bit segments in the frame time (block 655). As discussed above, the number of bit segments in the frame time can be dependent on factors such as a switching frequency of the rapidly switching light source, the state switching time of the light modulators in the SLM, the number of bits of image data (and the bit weighting scheme) to be displayed, amount of the frame time that must be devoted to SLM overhead, amount of the frame time that must be devoted to light source overhead, desired amount of light to display, and so forth. Then, a duty cycle for the various colors to be used can be determined (block 660). The duty cycle can be based upon a desired color point for the images being displayed in the SLM display system. The color point can be decomposed into percentages of the component colors, as discussed previously in FIG. 4. With the duty cycle for the various colors determined, an allocation of the bit segments to the frame time can be made based upon the duty cycle (block 665). For example, if the duty cycle is 48% green, 22% red, and 30% blue and there are a total of 200 bit segments in the frame time, then 96 bit segments can be allocated to green, 44 bit segments can be allocated to red, and 60 bit segments can be allocated to the blue.

The allocated bit segments can then be ordered to optimize performance (block 670). Several techniques exist for ordering the allocated bit segments to optimize image quality, with a goal of minimizing PWM noise and temporal contouring. The ordering can be performed by referencing previously designed and stored color sequences. Finally, the bit segments can be spliced (interleaved) together to form a single chain for all colors (block 675). The splicing can follow basic rules to optimize various performance criterions. For example, the splicing (interleaving) of the bit sequences can follow the following rules: a) Mini-subsequences should be evenly spaced for each color throughout the frame time; b) For optimal reduction of color separation artifacts, single bit segment subsequences are optimal. However, the use of single bit segment subsequences can result in reduced brightness. Therefore, to emphasize brightness, short subsequences (3 to 4 bit segments) can be formed; c) Evenly splice the subsequences of a single color so that each has equal duration and are evenly spaced through the frame time; d) Combine subsequences of a single color as to maximize single color duration.

The duty cycle, the bit allocation, and the spliced bit sequences can be changed if the operating environment of the SLM display system, the nature of the images being displayed, user settings, and so on, changes. As discussed previously, multiple spliced bit sequences can be computed and stored in a memory for a variety of conditions and a spliced bit sequence can be recalled from memory for use depending upon the conditions.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for creating a bit sequence, the method comprising:
determining a number of bit segments in a frame time;
determining a color sequence; and
specifying the bit sequence from the color sequence, wherein each bit in the bit sequence is delineated by a switching of a rapidly switching light source or a state change of a light modulator.

2. The method of claim 1, wherein the bit sequence is used in a display system, and wherein the frame time is approximately equal to an inverse of a product of a frame rate and a device load time of the display system.

3. The method of claim 1, wherein the color sequence is based on a desired color point, and wherein the desired color point can be specified in component colors.

4. The method of claim 3, wherein there are M component colors with M being an integer value, and wherein the desired color point can be specified as percentages of the M component colors.

5. The method of claim 4, wherein an allocation of the bit segments in the frame time is based upon the percentages of the M component colors.

6. The method of claim 4, wherein there are three component colors: red, green, and blue.

7. The method of claim 3, wherein the bit sequence is used in a display system, and wherein the desired color point can change based upon one or more of the following criterions: physical characteristics of the rapidly switching light source, optical characteristics of the rapidly switching light source, an operating environment of the display system, spectral characteristics of images, and a number of bits of image data.

8. The method of claim 1, wherein the specifying comprises distributing the color sequence through the frame time.

9. The method of claim 8, wherein the distributing comprises arranging the bit sequence to maximize one-bit segments.

10. The method of claim 8, wherein a bit subsequence comprises a bit sequence of more than one bit, and wherein the distributing comprises arranging the bit sequence so that bit subsequences of a single color are substantially equal in duration and distributing the bit sequence so that bit subsequences of a single color are substantially equally distributed throughout the frame time.

11. The method of claim 8, wherein a bit subsequence comprises a bit sequence of more than one bit, and wherein the distributing comprises arranging the bit sequence so that a duration that the rapidly switching light source remains producing a light of a single color is maximized.

12. The method of claim 1 further comprising after the determining of the color sequence, ordering the color sequence.

13. The method of claim 12, wherein the ordering is based on order information stored in a database.

14. A method for creating a bit sequence for displaying image data, the method comprising:
computing a frame time;
determining a number of bit segments displayable in the frame time;
determining a color sequence, wherein the color sequence is based upon a desired color point;
ordering the color sequence; and
specifying a bit sequence from the ordered color sequence, wherein each bit in the bit sequence is delineated by a switching of a rapidly switching light source or a state change of a light modulator.

15. The method of claim 14, wherein a bit segment represents a smallest displayable amount of light.

16. The method of claim 14, wherein the desired color point can be specified as percentages of component colors, and wherein an allocation of the bit segments in the frame time is made based upon the percentages of the component colors.

17. The method of claim 16, wherein the ordering occurs for each component color separately.

18. The method of claim 14, wherein the specifying comprises distributing the color sequence through the frame time.

19. The method of claim 18, wherein the distributing comprises arranging the bit sequence to minimize pulse width modulation contouring.

20. The method of claim 14, wherein the bit sequence is used to display image data in a display system, and wherein the bit sequence specifies a color produced by the rapidly switching light source and a duration of the color.

21. The method of claim 20, wherein the display system makes use of an array of spatial light modulators to display the image data, wherein the array of spatial light modulators is a digital micromirror device.

22. The method of claim 20, wherein the display system makes use of an array of spatial light modulators to display the image data, wherein the array of spatial light modulators is a liquid crystal display.
